(19) United States
(12) Patent Application Publication
(10) Pub. No.: US 2014/0331088 A1
(43) Pub. Date: Nov. 6, 2014

(54) COMPUTER AND METHOD FOR TESTING ELECTRONIC DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: DONG-YAN LI, Shenzhen (CN); BING ZHOU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/951,383

(22) Filed: Jul. 25, 2013

(30) Foreign Application Priority Data
May 6, 2013 (CN) 2013101681689

(51) Int. Cl. G06F 11/36

(52) U.S. Cl. CPC G06F 11/36
USPC 714/25

(57) ABSTRACT

A computer-implemented method for testing an electronic device connected to a computer includes obtaining testing parameters for items to be tested from a table stored in the computer. The table records a number of to-be-tested items of the electronic device, as well as testing parameters for testing each to-be-tested item. Each to-be-tested item is tested according to the obtained testing parameters.

### BACKGROUND

1. Technical Field

The present disclosure relates to computers, and particularly to a computer and a method for testing electronic devices.

2. Description of Related Art

In producing electronic devices, a number of items need to be tested to check whether or not the electronic devices are qualified products. However, as testing parameters for test items are different, programmers have to design different programs to test each item separately, which decreases work efficiency.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure.

Moreover, in the drawings, like reference numerals designate corresponding portions throughout the several views.

FIG. 1 is a block diagram of a computer for testing electronic devices, in accordance with an exemplary embodiment.

FIG. 2 is a schematic view of a table provided by the system of FIG. 1, in accordance with an exemplary embodiment.

FIG. 3 is a flowchart of a method for testing electronic devices, in accordance with an exemplary embodiment.

### DETAILED DESCRIPTION

Embodiments of the present disclosure are described, with reference to the accompanying drawings.

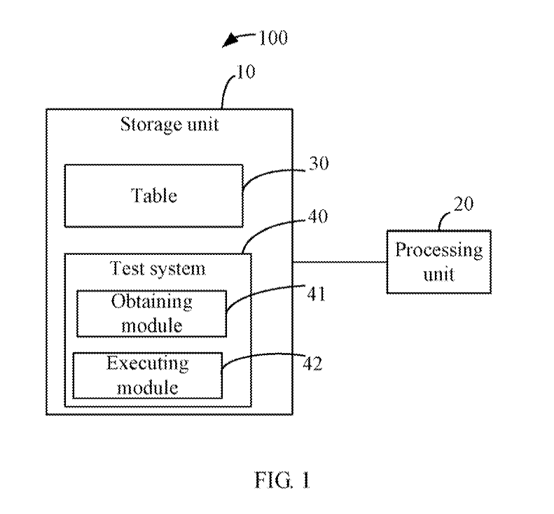

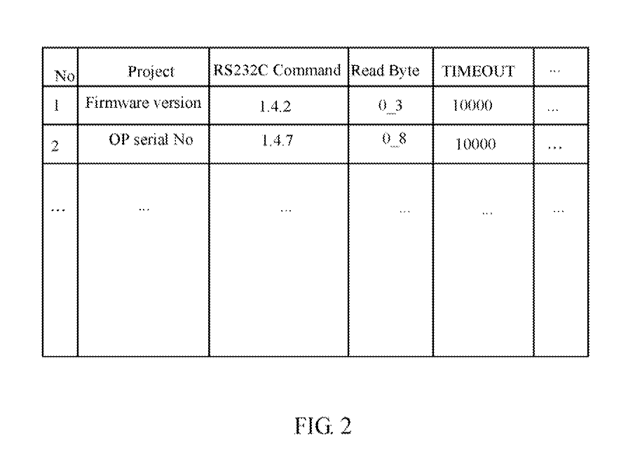

Referring to FIGS. 1-2, a computer 100 for testing an electronic device (e.g. smart phone) connected to the computer 100 includes a storage unit 10 and a processing unit 20. The storage unit 10 stores a table 30 that records a number of to-be-tested items of the electronic device, and testing parameters for testing each to-be-tested item. In this embodiment, the table 30 is a comma-separated values (CSV) file. The to-be-tested items may include whether or not a firmware version is right, whether or not an operator serial number is right, or the like. The storage unit 10 further stores executable instructions of a test system 40. The test system 40 is executed by the processing unit 20 to perform operations of testing each to-be-tested item of the electronic device. The test system 40 includes an obtaining module 41 and an executing module 42.

The obtaining module 41 obtains the testing parameters for testing each to-be-tested item from the table 30. The executing module 42 tests each to-be-tested item according to the obtained testing parameters. With this configuration, the test system 40 finishes testing each to-be-tested item of the electronic device according to the testing parameters included in the table. Thus, there is no need to design different programs for testing items that have different testing parameters.

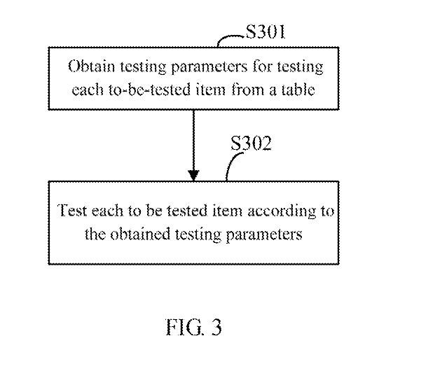

FIG. 3 is a flowchart of a method for testing an electronic device, in accordance with an exemplary embodiment.

In step S301, the obtaining module 41 obtains the testing parameters for testing each to-be-tested item from the table.

In step S302, the executing module 42 tests each to-be-tested item according to the testing parameters of each to-be-tested item.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A computer comprising:
one or more processing units; and
a storage unit storing a table recording a plurality of to-be-tested items and testing parameters for testing each to-be-tested item, the storage unit having instructions stored thereon which, when executed by the one or more processing units, cause the one or more processing units to perform operations of testing an electronic device connected to the computer, the operations comprising:
obtaining the testing parameters for testing each to-be-tested item from the table; and
testing each to-be-tested item according to the obtained testing parameters.

2. The computer as described in claim 1, wherein the table is a comma-separated values (CSV) file.

3. A computer-implemented method for testing an electronic device connected to a computer, comprising:
obtaining testing parameters for testing each of a plurality of to-be-tested items from a table; and
testing each to-be-tested item according to the obtained testing parameters.

4. The method as described in claim 1, wherein the table is a comma-separated values (CSV) file.

5. A computer-readable storage medium encoded with a computer program, the program comprising instructions that when executed by one or more computers cause the one or more computers to perform operations for testing an electronic device connected to a computer, the operations comprising:
obtaining testing parameters for testing each of a plurality of to-be-tested items from a table; and
testing each to-be-tested item according to the obtained testing parameters.

6. The storage medium as described in claim 5, wherein the table is a comma-separated values (CSV) file.
